(19) United States
(12) Patent Application Publication
(10) Pub. No.: US 2006/0065671 A1
(43) Pub. Date: Mar. 30, 2006

(54) Self-contained adhesive metering apparatus

(75) Inventors: Leslie J. Varga, Cumming, GA (US); Olivier Y. Huss, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 11/231,454

(22) Filed: Sep. 21, 2005

Related U.S. Application Data
(60) Provisional application No. 60/612,974, filed on Sep. 24, 2004.

(51) Int. Cl. G01F 11/00

(52) U.S. Cl. 222/1; 222/82

(57) ABSTRACT

An apparatus for dispensing liquid includes a cartridge assembly having a housing with an opening at one end and a first passage at an opposite end. The opening and the first passage communicate with an interior space of the housing. A cartridge of the liquid is insertable through the opening into the interior space and openable thereafter at the end of the housing opposite to the open end such that the liquid can flow into the first passage. A metered dispensing assembly is coupled with the cartridge assembly and includes a positive displacement pump in fluid communication with the first passage of the cartridge assembly and a valve module disposed downstream of the positive displacement pump and in fluid communication with the pump for selectively dispensing the liquid.

### CROSS REFERENCES

This application claims the priority benefit of U.S. Provisional Patent Application Ser. No. 60/612,974, “Self-Contained Adhesive Metering Apparatus”, filed Sep. 24, 2004, which is expressly incorporated by reference herein in its entirety.

### BACKGROUND

The present invention generally relates to dispensing liquids, such as adhesives, and especially to dispensing hot melt adhesives such as reactive hot melt adhesives.

Hot melt adhesives are used in a wide variety of applications. In certain applications, relatively high bond strengths are required and polyurethane reactive (PUR) hot melt adhesives have been used due to the relatively high bond strengths they create. However, other characteristics of these adhesives provide various manufacturing challenges. For instance, PUR's react with atmosphere and must therefore be melted in a closed container. Accordingly, typical adhesive supply systems associated with PUR's include a closed melter unit that supplies heated adhesive to a gear pump. The adhesive is then supplied through a heated hose, to maintain the required temperature, to a dispensing head.

However, when PUR's are used in applications requiring relatively small quantities of adhesive per unit, such as the sealing of battery packs for personal computers, the residence time of the adhesive within the heated hose can exceed the “pot life” of the adhesive, where “pot life” is the maximum time at operating temperature before the adhesive starts to degrade resulting in increased viscosity and charring. Exceeding the pot life of an adhesive can result in operational problems, such as filter clogging, and the cleaning required after charring has occurred.

In U.S. application Ser. No. 10/896,105, “RECHARGEABLE DISPENSING HEAD” filed Jul. 21, 2004, which is assigned to Nordson Corporation, Westlake, Ohio (the assignee of the present invention), a dispensing system is disclosed which utilizes a docking station to enable refilling of a tank associated with a valve module for dispensing adhesive and eliminates the need for the heated hose of prior systems. The docking station includes a bulk supply of the adhesive and, when the tank or reservoir coupled to the valve module is sufficiently depleted of its supply of adhesive, the tank and module assembly is moved to the docking station and coupled to the bulk supply of adhesive to refill the tank. The module and tank is then disconnected from the docking station and moved to one or more locations which require the dispensed adhesive, such as by the use of a robotic arm.

It would be desirable to provide a dispensing system which does not require a large supply of adhesive to be maintained, such as the docking station supply in the above-referenced patent application, and which is especially suited to the use of reactive hot melt adhesives. In particular, these adhesives cure very quickly when exposed to atmosphere, and specifically to moisture in the atmosphere.

### SUMMARY

According to a first aspect of the present invention, an apparatus is provided for dispensing liquid comprising a cartridge assembly having a housing with an opening at one end and a first passage at an opposite end. The opening and the first passage communicate with an interior space of the housing. A cartridge of liquid, such as reactive hot melt adhesive, is insertable through the opening into the interior space and is openable thereafter at the opposite end of the housing such that the liquid can flow into the first passage. A metered dispensing assembly is coupled with the cartridge assembly and includes a positive displacement pump in fluid communication with the first passage of the cartridge assembly and a valve module disposed downstream of and in fluid communication with the positive displacement pump for selectively dispensing the liquid. The valve module is effective for providing a positive fluid shutoff when closed.

The cartridge assembly can have an element that automatically opens the cartridge when it is placed into and secured within the housing in a sealed, but removable, condition. Such an element can be a piercing member that includes the first passage discussed above. The bottom of the cartridge can include a frangible portion that is opened by the piercing member to allow liquid flow from the cartridge into the first passage. The cartridge is preferably thermally conductive and at least one heater is in thermal communication with the housing for maintaining a thermoplastic material, such as hot melt adhesive at the proper temperature.

The positive displacement pump can be a gear pump and the metered dispensing assembly can further include a drive motor coupled to the pump, with the pump including a fluid inlet in fluid communication with the first passage of the cartridge assembly and a fluid outlet in fluid communication with the valve module.

The cartridge assembly can further include a cap secured to the housing, with the cap being configured to receive pressurized air from an external source and to direct the air onto a movable piston of the cartridge, thereby forcing the liquid to flow into the first passage. A check valve can be disposed downstream of the first passage and oriented to prevent the flow of liquid through the first passage back into the cartridge.

The apparatus can further include a recirculation valve having a fluid inlet and a fluid outlet, with the fluid inlet of the recirculation valve being in fluid communication with the fluid outlet of the pump and the fluid outlet of the recirculation valve being in fluid communication with the fluid inlet of the pump. The dispensing valve is closed when the recirculation valve is open.

According to a second aspect of the present invention, a method is provided for dispensing liquid from an apparatus including a cartridge assembly having a housing and a dispensing assembly having a gear pump and valve module, with the method comprising the steps of inserting a cartridge of the liquid through an opening formed in one end of the housing and opening a frangible portion of the cartridge with a piercing member disposed at an opposite end of the housing. The method further includes the steps of forcing the liquid to flow through a passage formed in the piercing member and to the gear pump which is disposed upstream of the valve module of the dispensing assembly, metering the flow of the liquid through the gear pump to the valve module, and discharging the liquid from the apparatus through the valve module.

The method can also include the following additional steps: heating the housing, thereby transferring heat to the cartridge and a liquid within the cartridge, to maintain the liquid at the desired temperature; recirculating the liquid from a location downstream of the gear pump to a location upstream of the gear pump, and through the gear pump, when the valve module is closed; and preventing the liquid from flowing back through the passage formed in the piercing member into the cartridge.

The step of discharging can further comprise directing the liquid from the valve module through a nozzle. The step of forcing can further comprise the step of directing pressurized air against a piston of the cartridge, with the piston being disposed at an end opposite the frangible portion of the cartridge.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a perspective view illustrating a dispensing apparatus constructed in accordance with the invention.

FIG. 1A is a fragmentary view, in cross-section, further illustrating the valve module and nozzle shown in FIG. 1, with the valve module in an open position;

FIG. 1B is a fragmentary view, in cross-section, similar to FIG. 1A but with the valve module in a closed position.

FIG. 2 is an elevational view of the apparatus shown in FIG. 1.

FIG. 3 is a cross-sectional view taken generally axially along the longitudinal extent of the cartridge assembly associated with the apparatus of FIGS. 1 and 2.

FIG. 4 is a perspective view of a piercing member associated with the cartridge assembly shown in FIG. 3.

FIG. 5 is a schematic representation of an adhesive flow circuit through the dispensing apparatus according to one embodiment of the present invention; and

FIG. 6 is a schematic representation of an adhesive flow circuit through the dispensing apparatus according to an alternate embodiment of the present invention.

### DETAILED DESCRIPTION OF THE DRAWINGS

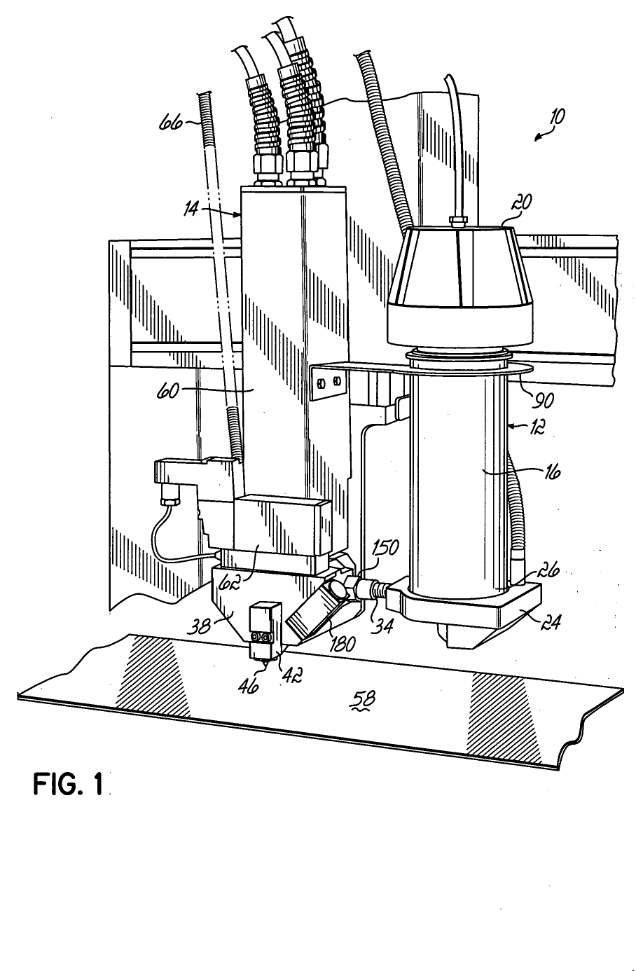

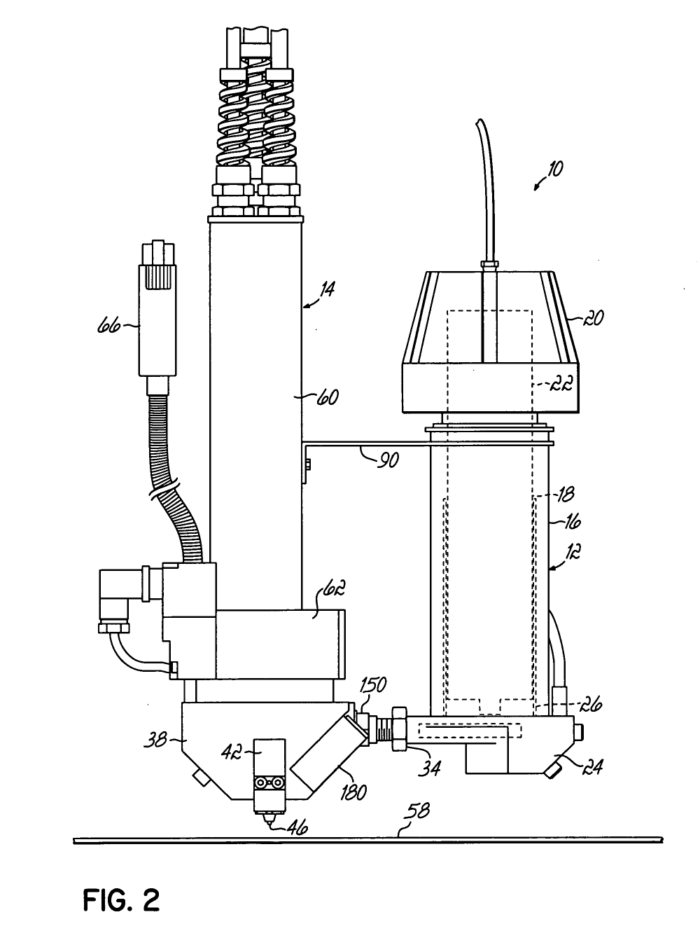

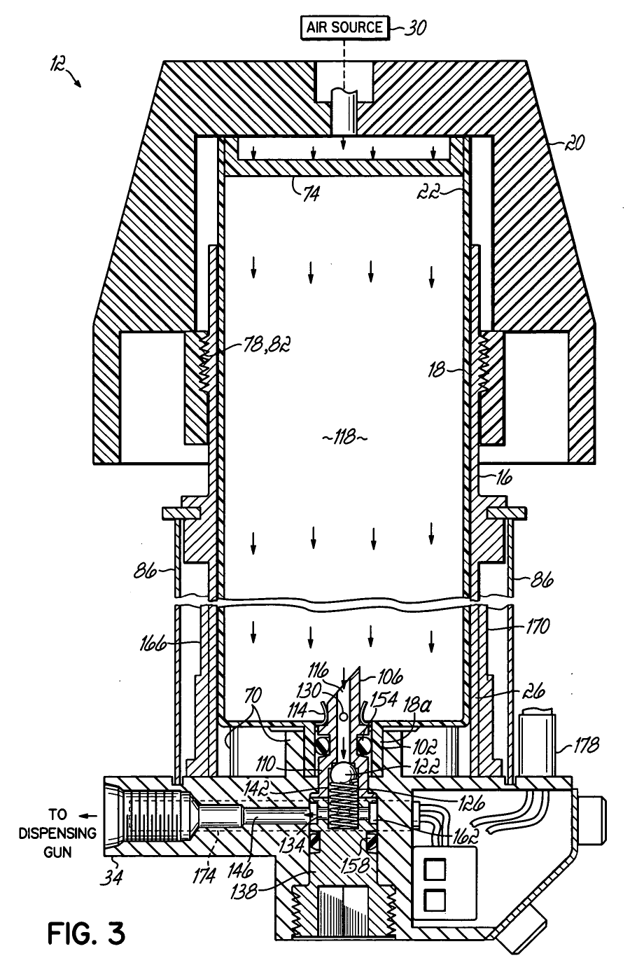

Referring first to FIGS. 1 and 2, an apparatus 10 constructed in accordance with the invention generally includes a cartridge assembly 12 and a metered dispensing assembly 14. The cartridge assembly 12 includes a cartridge jacket or housing 16 that can be in the form of a heated cylinder which is configured to receive a disposable cartridge 18 of an adhesive material such as a reactive hot melt adhesive. At room temperature, the adhesive is a solid material. Heat transfer from the heated cylinder 16 to the cartridge 18 changes the solid adhesive to a molten, liquid adhesive. If an off-line heater, such as a heated changeover unit as subsequently discussed is used to heat the cartridge 18 prior to insertion into housing or cylinder 16, the adhesive is already in a molten condition when cartridge 18 is inserted into housing 16. Cartridge 18 has a shape that is complimentary to the shape of housing 16 to fit within housing 16. In the illustrative embodiment, both housing 16 and cartridge 18 are cylindrical and cartridge 18 fits closely within the cylindrical interior of the housing 16. The cartridge assembly 12 includes a cap 20 at the top 22 and a manifold 24 at the bottom 26. The cap 20 at the top 22 receives pressurized air from a suitable source 30 (FIG. 3) for purposes to be described below, and the manifold 24 at the bottom 26 directs the hot melt adhesive from the cartridge 18 through a connector 34 to the dispensing assembly 14. The dispensing assembly 14 generally includes a manifold 38 which receives the liquid adhesive from the cartridge manifold 24. A dispensing valve module 42 is physically and fluidly coupled to manifold 38 and dispenses the liquid adhesive from a nozzle 46. Valve module 42 provides a positive fluid shutoff when it is closed. One suitable dispensing valve module 42 is the H100 valve module obtainable from Nordson Corporation, Westlake, Ohio.

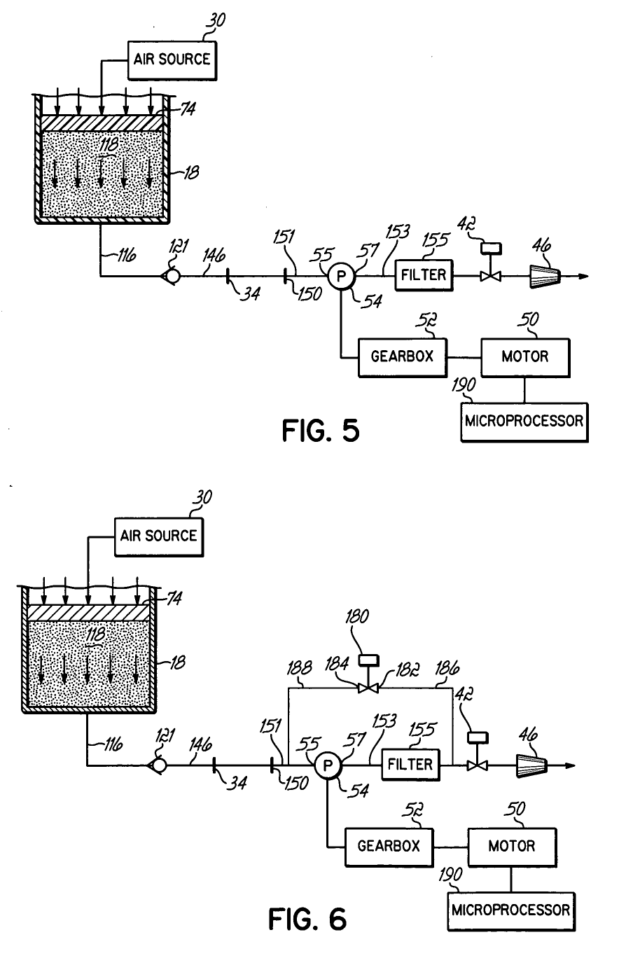

For purposes of directing precise amounts of the adhesive through the nozzle 46, the metered dispensing assembly 14 further includes a drive motor 50 and gear box 52 (FIGS. 5 and 6) coupled to a positive displacement pump such as a precision gear pump 54 which receives the hot melt adhesive from a passageway 151 (FIGS. 5 and 6) formed in manifold 38 and precisely meters the liquid adhesive through another passageway 153 formed in manifold 38 and a filter 155, through valve module 42, and finally, through the nozzle 46 onto a substrate 58. Alternative positive displacement pumps that can be used in lieu of the precision gear pump 54, include, but are not limited to, a piston pump, a progressive cavity pump, a metered rod pump, a gerotor pump and a peristaltic pump. The adhesive flow circuit is illustrated schematically in FIG. 5 and a subsequently discussed alternate adhesive flow circuit is illustrated schematically in FIG. 6. A solenoid valve 62 (FIG. 1) can be used to selectively provide operating air to the valve module 42 for operating a reciprocating valve element therein 43 as is known in the art. Valve element 43 reciprocates between an open position shown in FIG. 1A and a closed position shown in FIG. 1B, which correspond to the open and closed positions, respectively, of valve module 42. Drive motor 50, gear box 52 and gear pump 54 can be housed within housing 60 of dispensing assembly 14. A cord set 66 provides power to a heating element (not shown) within manifold 38 of the dispensing assembly 14 and to a resistive temperature detector (RTD, not shown). The heating element, RTD, and an associated temperature controller (not shown) can be used to maintain manifold 38, and the liquid adhesive flowing through manifold 38, at the desired temperature during operation.

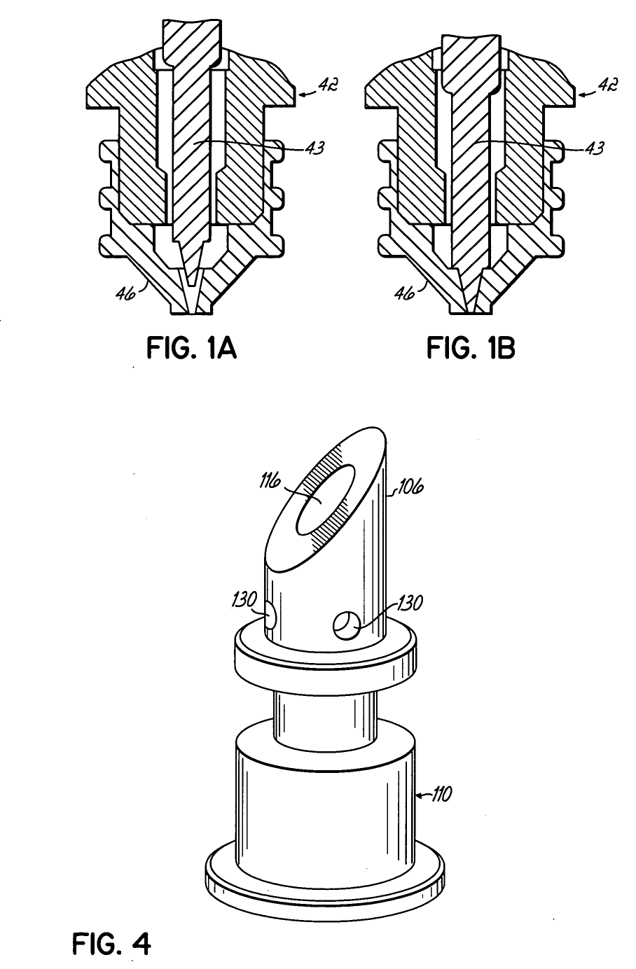

Referring now to FIGS. 3 and 4, the top 22 of jacket or housing 16 is open and the bottom 26 includes a cartridge support member 70. The cap 20 is secured to the housing 16 by respective internal and external threads 78, 82. The housing 16 is held in an upright position with respect to the cartridge manifold 24 by a suitable support 86 and is mounted to the dispenser assembly 14 by a bracket 90 (FIGS. 1 and 2). Cartridge 18 includes a bottom which rests against cartridge support member 70. Cartridge 18 further includes a protruding portion 18a which is received within a complimentary shaped recess 102 in the support member 70. The top of the cartridge 18 is closed and sealed by a movable piston member 74 which may be forced in a downward direction, as viewed in FIG. 3, by pressurized air introduced from source 30. This forces the liquid adhesive out of cartridge 18 as discussed below.

As shown in FIG. 3, when the cartridge 18 is inserted into the jacket 16 such that the bottom of cartridge 18 abuts the cartridge support member 70, a piercing member 106 of a nozzle 110 penetrates through a frangible membrane 114 located at the protruding portion 18a of the cartridge 18 such that an internal passageway 116 of the piercing member 106 communicates with the interior 118 of the cartridge 18. The nozzle 110 further includes a check valve 121 (FIGS. 5 and 6) in the form of a ball 122 and spring 126 (FIG. 3) which allow flow out of cartridge 18 in the direction shown by the arrows but will not allow flow in a reverse direction into the cartridge 18. Additional radial holes 130 are provided in the piercing member 106 to allow additional fluid paths into the internal passageway 116 of the nozzle 110. A plurality of radially-directed holes 134 are also formed in a second, separate piece 138 abutting the nozzle 110. These holes 134 allow flow from the chamber 142 which contains the ball 122 and the spring 126 to a passageway 146 in the cartridge manifold 24 which is fluidly coupled to the dispensing manifold 38 (FIG. 2) with a fitting 150 (FIGS. 1 and 2). As shown in FIG. 3, in the illustrative embodiment piece 138 is a threaded plug that holds the nozzle 110 in the position shown, and respective O-rings 154, 158 provide liquid seals on opposite sides of the fluid passageway 146, as well as an annular recess 162 communicating with radial holes 134.

Respective heaters 166 and 170 are provided in thermal communication with housing 16 and a heater 174 is disposed within the cartridge manifold 24 for ensuring that the hot melt adhesive is maintained at a proper temperature. A cord set 178 is provided to supply electrical power to the heaters 166, 170, 174, as well as to a resistive temperature detector (RTD, not shown).

The cartridge assembly 12 is preferably close coupled to the metered dispensing assembly 14, with regard to the volumetric capacity of a network of fluid flow passages and hydraulic elements of the fluid flow circuit shown in FIG. 5 that are downstream of the disposable cartridge 18 that extend to and include nozzle 46 (passageway 116, check valve 121, etc.), to avoid the problem of exceeding the “pot life” of the liquid adhesive, and the associated problems of increased viscosity and charring, experienced by some prior art adhesive supply systems as discussed previously herein. More particularly, if the total volumetric capacity of the fluid elements downstream of cartridge 18 is “X” cubic centimeters (or other volumetric measure) and the volumetric capacity of cartridge 18 is “Y” cubic centimeters (or other volumetric measure), then according to one embodiment of the present invention, the ratio of “X” to “Y” has a value less than or equal to about ten percent. In another embodiment, the ratio of “X” to “Y”, has a value less than or equal to about four percent.

In certain scenarios where close control over the “knit-line” is required, it may be desirable to use a modified fluid flow circuit as shown in FIG. 6. The flow circuit shown in FIG. 6 includes an adhesive recirculation valve 180 that redirects the flow of adhesive back to an inlet 55 of pump 54 when the primary dispensing valve module 42 is closed. An inlet 182 of recirculation valve 180 is in fluid communication with an outlet 57 of pump 54 via a passageway 186 formed in manifold 38, filter 155 and passageway 153. An outlet 184 of recirculation valve 180 is in fluid communication with the inlet 55 of pump 54 via a passageway 188 formed in manifold 38. Passages 186 and 188 and valve 180 shown in FIG. 6 are not included in the foregoing ratio of “X” to “Y”.

Dispensing valve module 42 and recirculation valve 180 can be pneumatically operated valves. However, valves operated in other suitable manners are within the scope of the present invention. Dispensing valve module 42 and recirculation valve 180 can be actuated by a single, four port solenoid valve, such as solenoid valve 62, in a manner known in the art. Alternatively, valve module 42 and valve 180 can be actuated by a plurality of valves. Recirculation valve 180 is closed when dispensing valve module 42 is open and recirculation valve 180 is open when dispensing valve module 42 is closed. The function of the recirculation valve 180 is to balance the static to dynamic pressure ratio of the adhesive by continuing to rotate the pump with the recirculation valve 180 open. This acts to eliminate any lead/lag issues with turning the motor on or off and enhances the ability to control the quality of the “knit line”.

The apparatus may respond to an analog signal from a speed sensing device (not shown) that is proportional to the speed of any robot (not shown) that may be carrying it. This analog signal can be supplied to a microprocessor 190 that is electrically coupled to motor 50. Additional control features include the ability to program an end-of-cycle adhesive flow reversal, using microprocessor 190, by reversing the direction and speed of the motor 50 and the metering gear pump 54. Reversing the direction and speed of the motor 50 and pump 54 at the end of each cycle also assists in maintaining close control over the “knit line”, such that the “knit line” can be substantially imperceptible, which can be an advantage in certain applications.

A heated changeover unit (not shown) can be provided to eliminate down time between cartridge changes by monitoring the number of cycles and the amount of adhesive used per cycle to then in turn determine when the controls would command the backup cartridge of the adhesive to start warming so that the adhesive in the backup cartridge is a molten, liquid adhesive at a point in time when the cartridge of adhesive currently being dispensed from becomes empty.

While the present invention has been illustrated by a description of various embodiments and while these embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of the general inventive concept.

What is claimed is:

1. An apparatus for dispensing liquid, comprising:
a cartridge assembly having a housing with an opening at one end and a first passage at an opposite end, said opening and said first passage communicating with an interior space of said housing, wherein a cartridge of the liquid is insertable through the opening into the interior space and openable thereafter at said opposite end such that the liquid can flow into said first passage, and
a metered dispensing assembly coupled with said cartridge assembly and including a positive displacement pump in fluid communication with said first passage of said cartridge assembly and a valve module having open and closed positions, said valve module being disposed downstream of and in fluid communication with said positive displacement pump for selectively dispensing the liquid.

2. An apparatus as recited in claim 1, wherein:
said metered dispensing assembly further includes a drive motor coupled to said positive displacement pump;
said positive displacement pump includes a fluid inlet in fluid communication with said first passage of said cartridge assembly and a fluid outlet in fluid communication with said valve module.

3. An apparatus as recited in claim 2, wherein:
said positive displacement pump is a gear pump.

4. An apparatus as recited in claim 2, further comprising:
a recirculation valve having a fluid inlet and a fluid outlet; wherein
said fluid inlet of said recirculation valve is in fluid communication with said fluid outlet of said positive displacement pump;
said fluid outlet of said recirculation valve is in fluid communication with said fluid inlet of said positive displacement pump; and
said dispensing valve is closed when said recirculation valve is open.

5. An apparatus as recited in claim 1, wherein:
said cartridge assembly further includes a cap secured to said housing, said cap being configured to receive pressurized air from an external source and to direct the air onto a movable piston of the cartridge, thereby forcing the liquid to flow into said first passage.

6. An apparatus as recited in claim 5, further comprising:
a check valve disposed downstream of said first passage and oriented to prevent the flow of the liquid through said first passage into the cartridge.

7. An apparatus as recited in claim 1, wherein:
said cartridge assembly further includes a piercing member, said first passage being disposed within said piercing member; and
said piercing member is operable to open a frangible portion of the cartridge when the cartridge is inserted through said opening of said housing, thereby allowing the liquid to flow into said first passage.

8. An apparatus as recited in claim 1, wherein:
said valve module includes a reciprocating valve element which reciprocates between open and closed positions.

9. An apparatus for dispensing liquids, comprising:
a cartridge assembly having a thermally conductive housing with an opening at one end and a piercing member with a first passage at and opposite end, said opening and said first passage communicating with an interior space of said housing, wherein a cartridge of the liquid is insertable through the opening into the interior space such that a frangible portion thereof is opened by said piercing member to allow liquid flow from the cartridge into said first passage;
at least one heater in thermal communication with said housing; and
a metered dispensing assembly coupled with said cartridge assembly and including a valve module fluidly coupled to said first passage of said cartridge assembly for selectively dispensing the liquid.

10. An apparatus as recited in claim 9, wherein:
said metered dispensing assembly includes a precision gear pump disposed upstream of said valve module.

11. An apparatus as recited in claim 9, wherein:
said interior space of said housing is cylindrical and a cylindrical cartridge of the liquid is insertable through said opening into said interior space.

12. A method for dispensing liquid from an apparatus including a cartridge assembly having a housing and a metered dispensing assembly having a gear pump and a valve module, said method comprising the steps of:
inserting a cartridge of the liquid through an opening formed in one end of the housing;
opening a frangible portion of the cartridge with a piercing member disposed at an opposite end of the housing;
forcing the liquid to flow through a passage formed in the piercing member and to the gear pump which is disposed upstream of the valve module of the dispensing assembly;
metering the flow of the liquid through the gear pump to the valve module; and
discharging the liquid from the apparatus through the valve module.

13. A method as recited in claim 12, further comprising the step of:
heating the housing thereby transferring heat to the cartridge and the liquid within the cartridge.

14. A method as recited in claim 12, further comprising the step of:
recirculating the liquid from a location downstream of the gear pump to a location upstream of the gear pump, and through the gear pump, when the valve module is closed.

15. A method as recited in claim 12, further comprising the step of:
preventing the liquid from flowing back through the passage formed in the piercing member into the cartridge.

16. A method as recited in claim 12, wherein said step of discharging further comprises:
directing the liquid from the valve module through a nozzle.

17. A method as recited in claim 12, wherein the cartridge further includes a movable piston disposed at an end opposite the frangible portion of the cartridge, and the step of forcing further comprises:
directing pressurized air against the piston of the cartridge so as to force liquid out of the cartridge into the passage formed in the piercing member.

18. A method of dispensing liquid from an apparatus including a cartridge assembly having a housing and a metered dispensing assembly having a positive displacement pump and a valve module, said method comprising the steps of:
inserting a cartridge of the liquid through an opening formed in one end of the housing, the cartridge having a first volume;
opening the cartridge;
causing the liquid to flow through a network of flow passages and hydraulic elements including the positive displacement pump and the valve module which is disposed downstream of the positive displacement pump, the network of flow passages and hydraulic elements having a second volume;
establishing a ratio of said second volume to said first volume of less than or equal to about ten percent;
discharging the liquid from the apparatus through the valve module.

19. A method as recited in claim 17, wherein said ratio of said second volume to said first volume is less than or equal to about four percent.
